(19) United States
(12) Patent Application Publication
(10) Pub. No.: US 2013/0242529 A1
(43) Pub. Date: Sep. 19, 2013

(54) COMPACT EMERGENCY LIGHTING SYSTEM

(71) Applicant: Anthony WONG, Pokfulam (CN)

(72) Inventor: Anthony WONG, Pokfulam (CN)

(73) Assignee: CRAWFORD TECHNOLOGY LIMITED, General Post Office (HK)

(21) Appl. No.: 13/746,809

(22) Filed: Jan. 22, 2013

Related U.S. Application Data
(63) Continuation of application No. 12/019,735, filed on Jan. 25, 2008, now abandoned.

(51) Int. Cl. F21S 9/02

(52) U.S. Cl. CPC F21S 9/022
USPC 362/20

(57) ABSTRACT

A compact emergency lighting system installed or preinstalled into a standard component of a building, comprising: at least one tiny and high flux luminary, such as a LED, which is installed on at least one side of the standard building component and powered by a battery backing up and charging unit coupling with an AC power supply. It is relatively simple in configuration, low in cost, easy to install, more durable, space-saving, causing minimal disruption to the outlook and design of the premises and provides with an extended operation time and reduced recharging time.

### CROSS-REFERENCE TO RELATED APPLICATION

This application is a continuation of application Ser. No. 12/019,735, filed on Jan. 25, 2008. The disclosures of the prior U.S. application is incorporated herein by reference.

### TECHNICAL FIELD

The present invention relates to an emergency lighting system, and more particularly to a compact emergency lighting system installed or preinstalled into a building as a standard component embedded and accompanied therewith.

### BACKGROUND OF THE INVENTION

Self-contained emergency luminaries or lighting units well known in the art are usually devised to be fully recessed into a wall / ceiling or being mounted thereon for providing emergency illumination in the event of a power failure, and such an emergency lighting unit generally comprises a case, a charger, a battery and at least one incandescent / tungsten / sealed beam lamp. Though such prior art units have been widely adapted for use, there are drawbacks and disadvantages existed therein. One drawback is that the installation of each of them requires extra spaces, additional power supplies and wiring. It is so much the worse when such units are installed in numbers within a multistorey building having numerous installation sites. Therefore, they are relatively time consuming and in turn expensive to install owing to higher labour cost incurred therefrom such that the extent to which they are employed will be somewhat limited. They also occupy more space and may be incompatible with the outlook or design of the premises or even render the surrounding environment more distasteful in appearance. Further, the life span of such emergency luminaries is usually around five years wherein the life span of the lamp is only last for around 1 to 2 years such that it needs to be tested and replaced periodically whereby hiking the repair and labour cost thereof. In addition, the lifespan of the battery is about 2 years depending on the type and wattage of the lamp. Once being fully charged, it enables the lamp to be illuminated at a specific lumen value for about 90 minutes. Afterwards, it takes roughly 24 hours to recharge the battery. In this regard, the emergency luminary will probably be deactivated during the recharging period such that inconveniences and even dangers might be caused in the event of a further power failure occurred shortly. Further, these and other prior art systems may have to be deactivated, disassembled and dismounted from the wall on which they are fixed during repair, renovation, refurbishment or redecoration of the building or individual unit, this will incur higher costs and cause inconvenience and danger to the occupiers since the chance of power failure due to faulty manual operations to the power system is likely to be higher during the repair, renovation, refurbishment or redecoration period.

### SUMMARY OF THE INVENTION

An object of the present invention is to overcome at least partly the above defects in the prior art by providing an emergency lighting system, which is relatively simple in configuration, low in cost, easy to install, more durable, space-saving, causing minimal disruption to the outlook or design of the premises, longer in operation time and shorter in recharging time.

Accordingly, the technical solution of the present invention provided for the above object being a compact emergency lighting system installed or preinstalled into a standard component of a building, comprising: at least one tiny and high flux luminary installed on at least one side of the standard building component and powered by a battery backing up and charging unit coupling with an AC power supply.

According to one embodiment of the present invention, the luminary is a LED; the standard component embedded comprises a stair, a stair handrail, a curtain wall, a sprinkler system, a window-related fixture and a door-related fixture, wherein the window-related fixture includes a window frame, window twist, window lock, window pull and the like, while the door-related fixture includes a doorframe, door/gate twist, door/gate lock, door/gate pull and the like.

More preferably, the invention provides a compact emergency lighting system preinstalled into a window frame, comprising: at least one luminary mounted on at least one side of the window frame; and a battery backing up and charging unit arranged in the window frame and electrically coupled to the at least one luminary for powering the at least one luminary; wherein the luminary, the battery backing up and charging unit, and electrical wires connecting the luminary with the battery backing up and charging unit are all embedded in the window frame during the manufacture of the window frame, such that they form together with the window frame as a prefabricated part with two ends of the electrical wires being exposed for electrical coupling to an external power supply to form a closed loop to power the luminary on.

According to another embodiment of the present invention, a transparent window is installed on the same side where the luminary is mounted thereby transmitting light from the luminary.

According to yet another embodiment of the present invention, the battery backing up and charging unit comprises a power converter section coupled with the power supply, a charging section having its input coupled with the power converter section and its output coupled with a rechargeable battery. Preferably, the battery backing up and charging unit might further comprises a charging stop section, and a charging restart and battery disconnect section. Further, the battery backing up and charging unit might comprise a light sensor section such that the present invention can be operated in accordance with the ambient brightness as required.

According to still another embodiment of the present invention, the rechargeable battery is configured to disconnect from the power supply with the charging stop section after the rechargeable battery is charged up to a predetermined upper level.

Preferably, the rechargeable battery is configured to connect to the charging section after the rechargeable battery is discharged down to a predetermined lower level while the power supply is active. Further, the rechargeable battery is configured to disconnect from the charging section after the rechargeable battery is discharged down to a predetermined lower level while the power supply is inactive.

According to the embodiments of the present invention, a compact emergency lighting system installed or preinstalled into a standard component of a building of the present invention is relatively simple in configuration, compact in size, low in cost and power consumption, and easy to install as no extra space, power supply or wiring is needed for installation after the building is equipped with the standard component embedded with the compact emergency lighting system of the present invention. Further, one of the major advantage or uniqueness of the present invention is that the emergency lightings system can be installed, embedded or incorporated into those standard building components as early as during the construction of a building or at any time thereafter, thereby it will not be affected, or least likely to be affected, by any subsequent repair, renovation or alteration of the building. It should be also appreciated that windows and door related fixtures such as window and door frames, window and door locks, and the like are not exhaustive examples of the present invention, which can be also adapted for use with other standard building components, such as a wall socket, and can also be extended to all building services components like air-conditioning fan coils, curtain walls, sprinkler systems or the like such that the extent to which the present invention is employed will be much larger than that of prior art systems.

### BRIEF DESCRIPTION OF THE DRAWINGS

The further objects, features, characteristics and effects of the present invention will be illustrated in more details by way of example with reference to the accompany drawings, wherein:

FIG. 1 is an exploded view of a compact emergency lighting system of the present invention being embedded into a window frame;

FIG. 2 is a block diagram of a compact emergency lighting system according to a preferred embodiment of the present invention; and

FIG. 3 is a circuit diagram of a compact emergency lighting system according to the preferred embodiment as shown in FIG. 2.

### DETAILED DESCRIPTION OF THE PREFERRED EMBODIMENTS

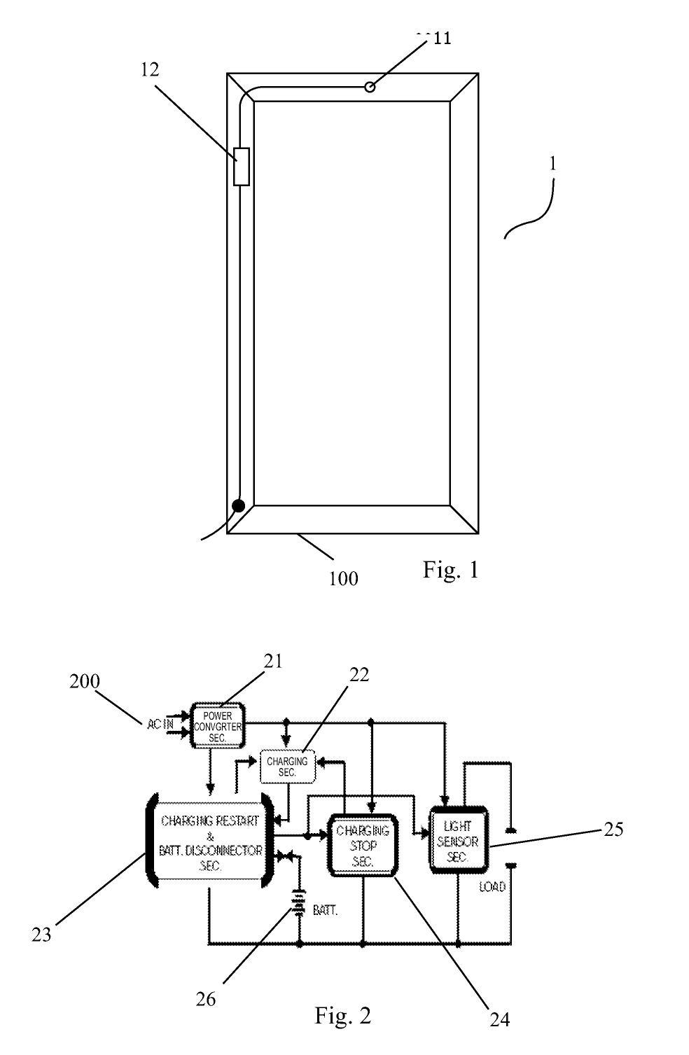

Now referring to FIG. 1, which illustrates an exploded view of a compact emergency lighting system 1 of the present invention, which is installed or preinstalled into a standard component of a building and comprises at least one tiny and high flux or super flux luminary 11 installed on at least one side of the standard building component and powered by a battery backing up and charging unit 12 coupling with an AC power supply (not shown), wherein the battery backing up and charging unit 12 comprises a PCB on which there is provided with a power converter section coupled with the power supply, a charging section having its input coupled with the power converter section and its output coupled with a rechargeable battery, such as a lithium battery. According to the present invention, the luminary is a LED and the lumen of the LED 11 can be higher than 150 and can be maintained over 50000 hours with a driving current smaller than 1000 mA such that the LED is ideal for replacing the existing lamps. Further, two or more LEDs can be powered by a single battery at the same time for achieving a required brightness, and wherein the battery can be arranged on or separated from the PCB for the ease of replacement. Preferably, the

PCB can be enclosed by a case on which additional means can be provided for enhanced positioning. According to another embodiment of the present invention, the luminary can be a halogen lamp or any other tiny lamp/bulb which can be fitted into a standard building component as requested.

According to the embodiment, the standard component can be window-related fixtures, door-related fixtures and the like, and wherein the window-related fixtures as shown is a window frame 100. Alternatively, it can be a window twist, window lock, window pull or the like. According to another embodiment of the present invention, the standard component can be door-related fixtures including a doorframe, door/gate twist, door/gate lock, door/gate pull and the like.

The compact emergency lighting system 1 of the present invention can be preinstalled into the window frame 100 before mounting into the building during the construction period thereof. Alternatively, it can be also installed in post-construction period as it can be fit into the space of the existing window frame 100 owing to its compact size. According to present invention, the compact emergency lighting system 1 can be made to be a recess type, surface mounted type or outside hanging type device such that it can be installed in almost anywhere in the building as requested.

According to another embodiment of the present invention, the compact emergency lighting system 1 can be installed into a sprinkler system (not shown) adopted in most modem buildings, wherein a LED is arranged nearby the sprinkler head of an automatic fire sprinkler such that it can provide emergency illumination in the event of a power failure when a fire broke out. Alternatively, it might be installed in a curtain wall (not shown) which is adapted for partition or decoration of the space inside the buildings and can be also found in almost everywhere in modem buildings.

It should be understood that the lighting system 1 of the present invention can provide not only an emergency illumination in the event of a power failure, but can also be employed as a night light, security light, signal light or decorative light as per request due to fact that it can be illuminated at an adoptable flux with a relatively low driving current for a much longer period than prior art approaches.

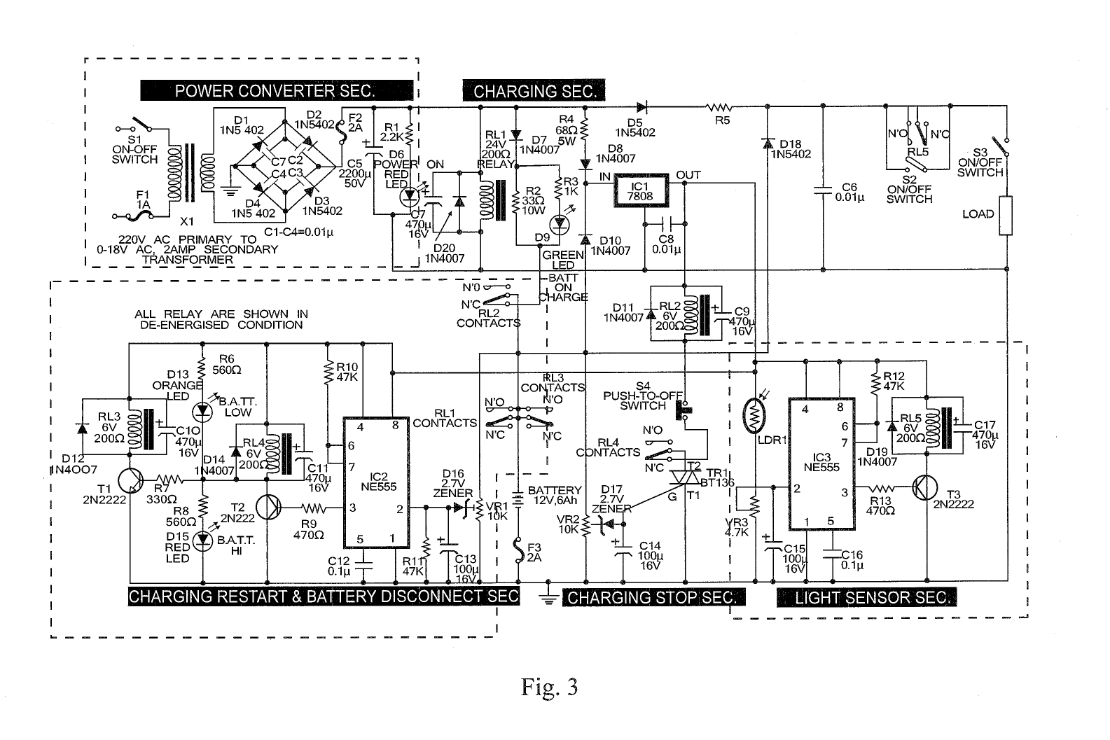

Referring to FIG. 2, a block diagram of a compact emergency lighting system 200 according to a preferred embodiment of the present invention is illustrated. The emergency lighting system 200 comprises a power converter section 21 coupled with a power supply AC IN, a charging section 22 having its input coupled with the power converter section 21 and its output coupled with a rechargeable battery 26 via a optional charging restart and battery disconnect section 23 which is connected to a optional charging stop section 24 and a optional light sensor section 25. The optional sections 23, 24, 25 are incorporated mainly for the optimization of the emergency lighting system 200, namely to lengthen the lifespan of the rechargeable battery and minimize the power consumption of the system.

FIG. 3 is a circuit diagram of a compact emergency lighting system according to the preferred embodiment as shown in FIG. 2. According to the embodiment of the present invention, the power supply of 220V AC is stepped down to 18V AC (RMS) by a 220V AC primary to 0-18V AC, 2A secondary transformer (X1). Diodes D1-D4 form a bridge rectifier and a capacitor C5 filters the voltage thereby providing an output voltage ˜25V DC at its two ends. The charging section includes a 33-ohm, 10-watt resistor R2 which limits the charging current to about 425 mA when the voltage of a rechargeable battery BATTERY drops to 10.2V, or to 325 mA when the battery is charged up to about 13.5V.

When the battery is charged to 13.5V (as set by VR2), a zener diode D17 goes into breakdown region thereby triggering a triac TR1, which conducts continuously even if the gate current is reduced to zero (by disconnecting the gate terminal). Once the battery is fully charged, the charging section is disconnected from the battery due to energisation of a relay RL2 which makes the connection therebetween breaks, even if the power fails because of the connection to the battery via a diode D10. S4, a normally closed switch, is included to enable manual restart of the charging process if required. The charging restart and battery disconnect section comprises an NE555 timer (IC2) wired in monostable mode. When the battery voltage is above 10.2V (as indicated by red LED D15), a zener diode (D16) remains in the breakdown region and makes the trigger pin 2 of IC2 high, thereby maintaining output pin 3 in a low voltage state. Thus, relay RL3 is on and relay RL4 is off. As soon as the battery voltage falls to about 10.2V (as set by preset VR1), the zener diode D16 comes out of conduction thereby making pin 2 low and pin 3 high to turn on a relay RL4 and an orange LED D13. This will also switch off a relay RL3 and a LED D15. If the power supply is active, charging restarts due to de-energisation of the relay RL2 because the relay RL4 breaks the circuit of relay RL2 and triac TR1 when it is on. However, if the power supply is inactive, both relays RL3 and RL1 will de-energise and disconnect the battery from the remaining circuit. Thus, when battery voltage falls to 10.2 volts, its further discharge will be avoided. As soon as the power supply resumes, it will energises the relay RL1 thereby connecting the battery again to the circuit.

The light sensor section also makes use of a 555 timer IC wired in the monostable mode, and wherein a light sensitive resistor LDR1 is connected across its pins 2 and 4 and the resistance of which is inversely proportional to the ambient brightness. When it is bright, the resistance of LDR1 is comparatively low. As a result, pin 2 of IC3 is held near Vcc and its output at pin 3 is kept at low level. In darkness, the resistance of the LDR1 is very high whereby rendering the voltage at pin 2 of IC3 to fall to near ground potential. As a consequence, output pin 3 goes high during the monostable pulse period, a forward biased transistor T3 goes into saturation and energizes a relay RL5. With an auto/bypass switch S2 being set off (in auto mode), the load will be connected to the power supply via a switch S3. If desired, the load may be switched on during the day-time by flipping the switch S2 to on position (by manual). Preset varistor VR3 to control the light sensitivity and the threshold light level at which the load will be automatically switched on/off.

Capacitors with the relays ensure that there is no chattering of the relays. When the power supply is present, a diode D8 couples the input voltage to regulator IC1 whereas diode D10 feeds the input voltage to it (from battery) in the absence of the power supply. Diode D5 connects the load to the power supply via resistor R5 when the power supply is available (while diode D18 does not conduct). However, when power supply fails, the situation reverses and diode D18 conducts while diode D5 does not conduct. The load can be any bulb of 12 volts with a maximum current rating of 2 amperes (24 watts), and in the present embodiment a super flux LED is employed as the load. Resistor R5 is supposed to drop approximately 12 volts when the load current flows through it when the power supply is active. Hence, the power dissipated in it would almost be equal to the load power. According to another embodiment, it is desirable to replace R5 with a LED of similar voltage and wattage so that the light flux is doubled during the presence of the power supply with respect to the case in which the load is fed from the battery due to the absence of the power supply.

In order to preset varistors VR1 and VR2, just take out (by desoldering one end thereof) diodes D7, D10 and D18 and connect a variable source of power supply in place of the battery. Adjust VR1 so that battery-high LED D15 is just off at 10.2V of the variable source. Increase the potential of the variable source and observe the shift of BATT LOW LED D13 to BATT HI LED D15. Now make the voltage of the source 13.5V and set VR2 so that the relay RL2 just energises. Then decrease the voltage slowly and observe such that relay RL2 does not deenergise above 10.2V. At 10.2V, LED D15 should be off and relay RL2 should deenergise while LED D13 should light up. Preset value of VR3 can be adjusted during evening hours so that the load can be turned on under a desired external brightness.

According to the present embodiment, it can be seen that the circuitry of the present invention is configured to provide the following features:

1. When the power supply (e.g. 220V AC) is active, it charges a 12V battery up to a upper threshold level, such as 13.5V, and then the battery is disconnected from the charging section.

2. When the battery discharges down to 10.2V, it is disconnected from the load and the charging process is resumed.

3. If the power supply is available and there is darkness in the room, the load (LED) will be turned on by taking power from the power supply; otherwise the battery is connected to the load.

4. When the battery discharges down to a lower threshold level such as 10.2V while the power supply is still not yet available, the battery will be completely disconnected from the circuit to avoid further discharge. Alternatively, the battery can remain to be connected or the lower threshold level can be adjusted to provide prolonged illumination if the length of the illumination is the prominent matter of concern.

While the invention has been described with references to above preferred embodiments, it will be understood by those skilled in the art that various changes, additions or deletions may be made and equivalents may be substituted for elements thereof without departing from the spirit and scope of the invention and its claims. The above embodiments are merely exemplary but not limitative examples. For example, it should be appreciated that the present invention may be installed to any parts of the buildings, such as ground, power switches / sockets and the like with or without any adaptive alterations in its design, dimension and materials in use, and all such alteration and/or modification shall fall into the scope of the present invention.

What is claimed is:

1. A compact emergency lighting system preinstalled into a window frame, comprising:
at least one luminary mounted on at least one side of the window frame; and
a battery backing up and charging unit arranged in the window frame and electrically coupled to the at least one luminary for powering the at least one luminary;
wherein the luminary, the battery backing up and charging unit, and electrical wires connecting the luminary with the battery backing up and charging unit are all embedded in the window frame during the manufacture of the window frame, such that they form together with the window frame as a prefabricated part with two ends of the electrical wires being exposed for electrical coupling to an external power supply to form a closed loop to power the luminary on.

2. An compact emergency lighting system according to claim 1, wherein the luminary is a LED.

3. An compact emergency lighting system according to claim 1, wherein a transparent window is installed on the same side where the luminary is mounted, to transmit light from the luminary.

4. An compact emergency lighting system according to claim 1, wherein the battery backing up and charging unit comprises:
a power converter section coupled with the power supply;
a charging section having its input coupled with the power converter section and its output coupled with a rechargeable battery;
a charging stop section configured to disconnect the rechargeable battery from the power supply after the rechargeable battery is charged up to a predetermined upper level; and
a charging restart and battery disconnect section configured to connect the rechargeable battery to the charging section after the rechargeable battery is discharged down to a predetermined lower level while the power supply is active and to disconnect the rechargeable battery from the charging section after the rechargeable battery is discharged down to the predetermined lower level while the power supply is inactive.

5. An emergency lighting system according to claim 4 wherein the predetermined lower level is a non-zero threshold level at which the rechargeable battery is prevented from enabling further discharge.

6. An emergency lighting system according to claim 1, wherein the system is configured to provide illumination after failure of mains power.

7. An emergency lighting system according to claim 1, wherein the battery backing up and charging unit further comprises a light sensor section which is embedded into the window frame during the manufacture of the window frame to form a part of the prefabricated part.
